(19) United States
(12) Patent Application Publication
(10) Pub. No.: US 2013/0013491 A1
(43) Pub. Date: Jan. 10, 2013

(54) SYSTEM AND METHOD FOR DETECTING AND MITIGATING DUPLICATE TRANSACTION FRAUD

(75) Inventors: Anthony J. Selway, Phoenix, AZ (US); Matthew J. Cottrell, Phoenix, AZ (US); Laura E. Weinflash, Scottsdale, AZ (US); Robert W. Weyrauch, Maricopa, AZ (US)

(73) Assignee: Early Warning Sevices, LLC, Scottsdale, AZ (US)

(21) Appl. No.: 13/451,039

(22) Filed: Apr. 19, 2012

Related U.S. Application Data
(60) Provisional application No. 61/477,096, filed on Apr. 19, 2011.

(51) Int. Cl. G06Q 20/38

(52) U.S. Cl. 705/39

(57) ABSTRACT

A method and system for reducing fraud by detecting duplicate financial transactions in a financial transaction processing system. In various embodiments, financial institutions can be alerted when a financial instrument such as a check is being tendered for deposit, wherein a previous deposit for that same instrument had previously been submitted at the same or a different financial institution. The system and method provide for detection of deposits of checks after remote deposit of the same check had been previously performed (for example by submitting a digital image of the check). Deposit of duplicate counterfeit paper checks issued to multiple parties can also be detected and mitigated.

This application claims the benefit of and is a non-provisional of co-pending U.S. Provisional Application Ser. No. 61/477,096 filed on Apr. 19, 2011, entitled “SYSTEM AND METHOD FOR DETECTING AND MITIGATING DUPLICATE TRANSACTION FRAUD,” which is hereby expressly incorporated by reference in its entirety for all purposes.

### BACKGROUND OF THE INVENTION

Banks and other institutions are exposed to loss from the fraudulent use of duplicate checks and other negotiable instruments. As an example, a fraudulent scheme may involve depositing multiple counterfeit copies of the same check into accounts at different banks during a relatively short period of time, and before it is known that there are insufficient funds to cover the check, the funds have been withdrawn from the accounts. More recently, with the rise in popularity of remote deposits using images of checks (e.g., accepting a check for deposit by having the account holder capture a digital image of the check at a portable device), a person making a remote deposit at a bank can later use the same check (either scanned or in paper form) to attempt to make a deposit at the same or a different bank.

### BRIEF SUMMARY OF THE INVENTION

Embodiments of the invention provide systems and methods for identifying duplicate transactions, such as the presentment of duplicate checks and other negotiable instruments.

In one exemplary embodiment, a method for determining that a transaction instrument has been used for conducting more than one transaction includes receiving, at a duplicate detection system, data records identifying instruments being presented to conduct transactions at one or more financial service organizations, storing the data records at the duplicate detection system, when a data record is received at the duplicate detection system, comparing the received data record to the stored data records to determine if the received record identifies the same instrument that is identified in any one of the stored data records, and if any two data records appear to identify the same instrument by matching or nearly matching predetermined criteria, generating an alert at the duplicate detection system to at least one of the financial service organizations where that instrument has been presented.

### BRIEF DESCRIPTION OF THE DRAWINGS

FIG. 1 is a block diagram illustrating a network in which a plurality of financial and other institutions are linked to a duplicate transaction detection system.

FIG. 2 illustrates exemplary functional modules within the processing system of the duplicate transaction detection system.

FIG. 3 illustrates a process for detecting duplicate check transactions in the network of FIG. 1.

FIG. 4 illustrates an alternative process for detecting duplicate check transactions.

FIG. 5 is yet another illustration of a process for detecting duplicate check transactions, and the messages sent in response to the duplicate transactions.

FIG. 6 is a block diagram illustrating an exemplary computer system upon which embodiments of the invention may be implemented.

### DETAILED DESCRIPTION OF THE INVENTION

There are various embodiments for implementing the present invention. Generally speaking, embodiments of the invention reduce or mitigate fraud by detecting and identifying duplicative financial instruments or transactions that are potentially improper or fraudulent.

In some embodiments, banks and other financial institutions that accept checks (items) for deposit or payment provide a record of the check transaction to a central duplicate detection system that receives transaction records from one or more institutions (as used herein, “institutions” may include any type of financial service organizations, such as banks, credit unions, investment firms, brokerages, credit card companies, loan companies, check cashing services, payday loan services, government institutions, or any other entity providing financial services). The records include data identifying the check that has been presented to the institution, such as ABA routing number, account number, check serial number, and in some instances, check amount. The records are stored at the central system, and as new records are received from participating financial institutions, each new record is compared to previous records to find any matches. It is to be understood that, although check transactions may be from participating or contributing institutions (institutions that submit checks for review), the records themselves may include checks written against accounts at non-participating institutions. Thus, the detection of duplicate transactions might be for checks presented to participating institutions, but written against both accounts at participating institutions (those that submit checks for duplicate transaction review) and accounts at non-participating institutions (those that might not send in presented checks for review).

It should also be appreciated that the present invention is not limited to detecting duplicate check transactions. Rather, in a broad sense, any transaction involving an instrument intended for a single use or for only a defined number of uses can be reviewed for fraud or misuse. As examples, such instruments may include negotiable instruments in general, as well as single (or limited) use credit or debit cards, vouchers, gift cards, redemption certificates, and any other instrument that has value and is intended for limited use. Further, the terms “instrument” and “transaction” are also used in a broad sense. For example, an instrument may include both tangible instruments (e.g., checks, cards, physical documents and so forth) and intangible or virtual instruments (e.g., a password or identifier that provides access to an account), and thus in some embodiments a detected duplicate instrument or transaction might include two transactions having similar identifying data but involving no tangible instrument.

In some embodiments, transactions records can be sent from participant institutions either in real time (as a transaction is being conducted), or in batch mode. For example, a bank or merchant can submit check information by scanning the check, such as by reading a magnetic ink character recognition (MICR) code, entering any other identifying or transaction data as appropriate (such as amount), and sending such check information to a duplicate detection system prior to final acceptance of the check for deposit or payment. A message can be returned in real time, informing the institution if the check has been matched to previous check transactions. As will be described later in greater detail, the detection system may also return other information such as a risk score associated with the check or associated with the account against which the check is drawn.

In other instances, an institution, such as a bank, may submit transaction records in batch form, say, at the end of each day. The records could be in the form of transit item files (data records of checks that have been presented to a bank and submitted for clearing through the Federal Reserve). Such checks and their records could each be reviewed against previous checks and records (in the form of transit item files) submitted for clearing, as well as checks for which records have been previously submitted in real time for review by the detection system.

As will also be described later, in some embodiments a process for determining whether a check is an improper duplicate may involve more than checking for matches. For example, in some circumstances, a check may be inadvertently processed or entered twice when received at a bank or other institution. A bank clerk may scan a check to create a record of it being presented, but before the check is bundled with other checks to be processed for clearing, it may be inadvertently scanned a second time. In other circumstances, some checks may be printed in duplicate, e.g., when an account holder (such as a business) orders new supplies of checks, and there is an overlap in serial numbers (sometimes inadvertent, and sometimes intentional in order to use serial numbers desired or favored by the account holder). In yet other instances, certain account holders may send out large numbers of checks all having an identical serial number and perhaps all for an identical amount (such as rebate checks issued by a merchant or manufacturer). Accordingly, in some embodiments of the invention, features are provided for filtering out or excluding certain check transactions from being identified as improper duplicates. In yet other embodiments, features are provided that assess the risk that a check is an improper or fraudulent duplicate (based on a factors or circumstances surrounding the check) and providing a risk score to the participating institution, either in lieu of or in addition to indicating whether or not the check is a duplicate.

Also, in some embodiments the duplicate detection system (and data associated with the risk of a check being a duplicate) can be used in conjunction with other systems for assessing risk or detecting fraudulent activity. Thus, embodiments herein can be used with systems for assessing the risk of return of checks drawn against particular checking accounts, such as exemplified in U.S. Pat. No. 7,383,227, entitled “Database For Check Risk Decisions Populated With Check Activity Data From Banks Of First Deposit,” issued Jun. 3, 2008 to Laura Weinflash et al, and can also be used with systems for generally detecting fraudulent activity, such as exemplified in U.S. Provisional Patent Application Ser. No.61/448,156, entitled “System And Method For Suspect Entity Detection And Mitigation,” filed Mar. 1, 2011 by Robin Love et al, the disclosures of which are incorporated herein by reference.

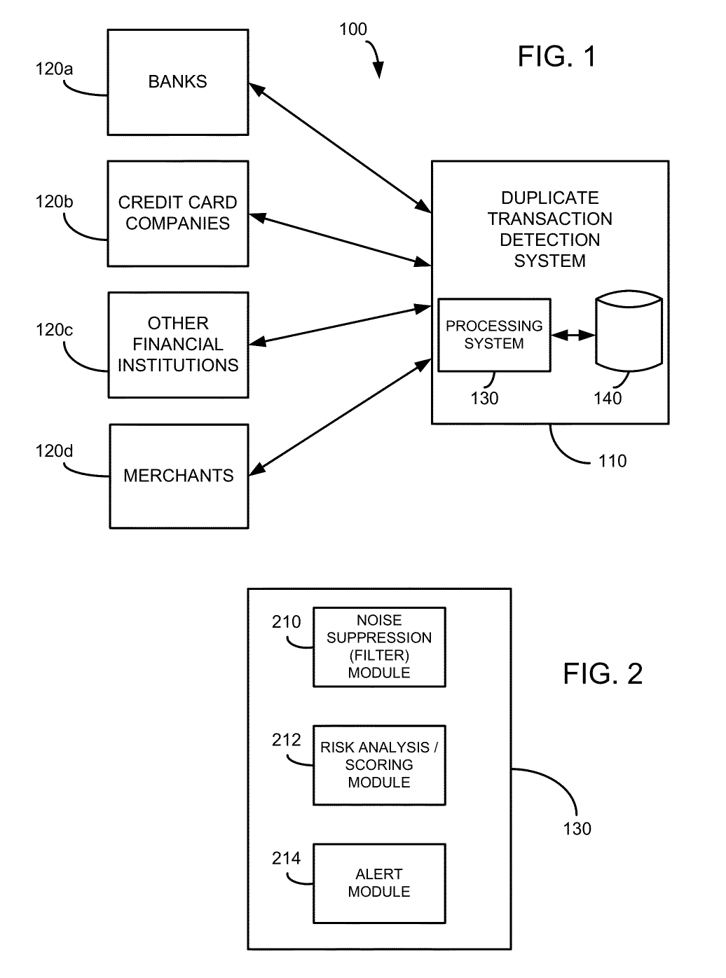

Turning now to the drawings, there is shown in FIG. 1 an exemplary network 100 in which a duplicate transaction detection system 110 is connected for receiving check or item transaction data from one or more institutions 120. As illustrated, the institutions 120 may include banks 120a (receiving checks presented for deposit or payment), credit card companies 120b (receiving checks as payment against card accounts), other financial institutions 120c (e.g., loan companies, check cashing companies, and brokerages that may receive checks for cash, for payment or for deposit), and merchants 120d (receiving payments from customers in the form of checks). It should be appreciated that the institutions 120 illustrated in FIG. 1 are only exemplary and not exclusive. In general, the institutions providing check data to duplicate detection system 110 could be any entity or person that might receive money or funds in the form of checks. It should be further appreciated that while the illustrated embodiments describe systems for reviewing and evaluating checks for duplicate transactions, as noted earlier, embodiments of the present invention may have application in other environments and be used for reviewing or evaluating any form of instrument (financial or non-financial) that may have monetary or other value.

While the duplicate transaction detection system 110 is illustrated as separate from each of the institutions 120 (and thus operated by a third party/entity apart from one of the institutions 120, as might be desirable in order to maintain an relationship independent from any one of the institutions), there are various alternate ways of operating the system 110, including the system being operated by one of the institutions 120.

The detection system 110 includes a processing system 130 and a data storage or memory device 140. The processing system 130 manages data that is received at system 110 and that relates to checks used for transactions (at the institutions 120) and stores such data at storage device 140. The processing system 110 also compares check data received from the institutions 120 against check data stored in storage device 140 in order to identify duplicative checks that are improper or fraudulent (or potentially improper or fraudulent), and generates alerts or notifications that provide notice back to institutions 120 that might receive (or be affected by) duplicative checks.

FIG. 2 illustrates certain functional features carried out by processing system 130 in order to detect and identify duplicate checks, and in particular illustrates those features as three programmed modules. It should be appreciated that in some embodiments the modules might represent executable software resident within internal memory of the processing system 130, and in other embodiments the modules might be downloaded from external memory devices (such as storage device 140) for execution at processing system 130. Other ways of implementing the modules in hardware and/or software are also possible.

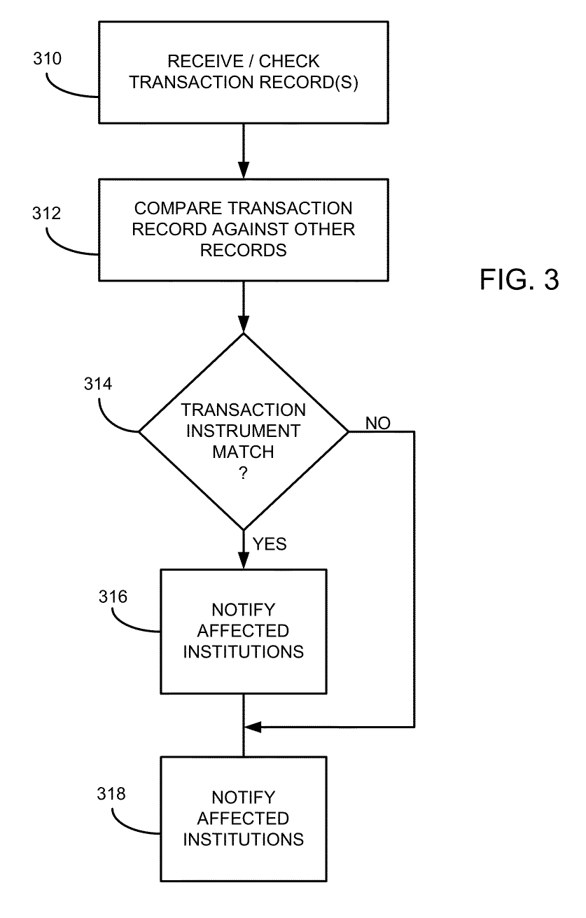

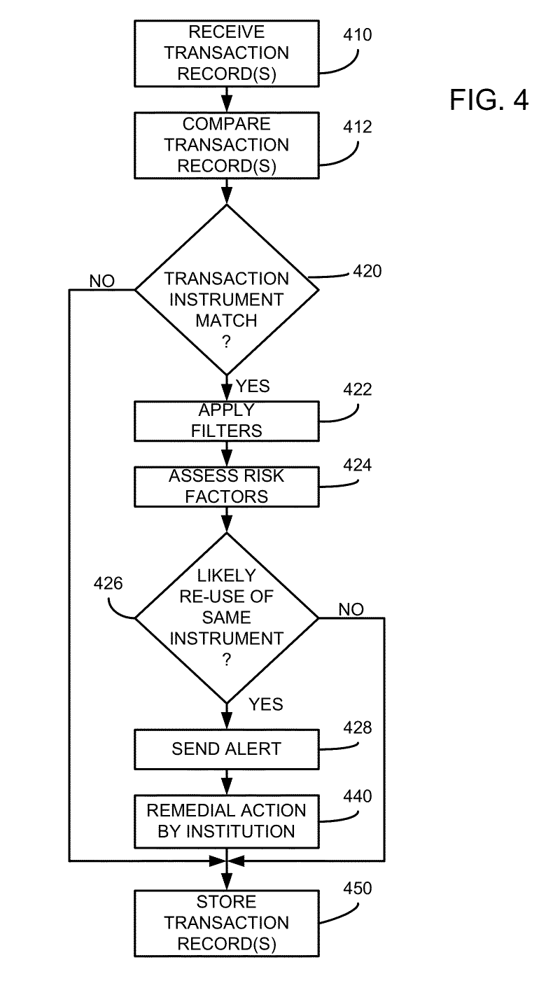

The modules within processing system 130 include a noise suppression (filter) module 210, a risk analysis/scoring module 212, and an alert module 214. Many of the specific functional features provided by these modules will be described later in conjunction with FIGS. 3 and 4. However, briefly, noise suppression module 210 provide filters that, when enabled, will exclude or suppress certain transactions from being identified as duplicate (e.g., when those transactions have characteristics that are determined to likely provide false positives, i.e., false matches with previous transactions). Risk analysis/scoring module 212 examines characteristics of matched transactions and assesses the likelihood that a transaction is in fact duplicative, and in some embodiments, provides a score that reflects the degree of likelihood. Alert module 214 provides an alert or notification to one or more of the institutions 120 when a record of a check transaction received at system 110 is determined to be (or likely to be) a duplicate and, hence, potentially improper or fraudulent. As should appreciated, the functionality generally depicted as being allocated to the three identified modules 210, 212 and 214 is so depicted for ease of description in illustrating some notable features of the invention, and various features necessary or desirable for implementation in those three modules could be combined into fewer than three modules or separated into more than three modules.

FIG. 3 is a simplified flow diagram illustrating the general operation of the system 110 in detecting and identifying duplicate check transactions, in accordance with one embodiment of the invention. As seen, the system 110 receives from the institutions 120 data records of checks used for transactions at the institutions, step 310. As described earlier, in some instances the receipt of a transaction record, such as at step 310, may represent receipt of a transaction record for a single check, e.g., resulting from real time scanning of a single check and submission of data for that check by one of the institutions at the time that transaction is conducted. In other cases, a group of checks may be received together, such as a large number of check records provided in batch mode (e.g., at the end of each day), and representing all the checks received by a financial institution that day and provided to system 110 in the form of transit item files that have been submitted for clearing.

At step 312, each check is compared against other checks (such as previously submitted checks) by comparing a transaction record received at system 110 against data records for other check transactions stored at memory device 140. If there is a match, step 314, then the processing system 130 generates alerts to notify institutions affected by the duplicate checks, step 316. If there is no match at step 314, or if there is a match and after notifications are sent at step 316, the current data record is stored (for comparison against future data records), step 318. It should be noted that the notifications sent at step 316 can be generated for distribution in various ways. In one embodiment, an alert is sent to the institution providing the current data record that gave rise to the match (i.e., the record that was matched against a previous transaction data record), and an alert is also sent to the institution that provided the previous (matched) transaction record. It should be noted that in many circumstances both institutions may have a need to know about the match, since both are or may be impacted by an improper or fraudulent use of the check in question. Also, it should be noted that the institution providing the initial data record (against which a subsequent check is matched), which may have had its check cleared (since it was first in time), could in fact be responsible for subsequent duplicate checks. Under some current financial regulations, banks accepting a check for deposit in the form of a scanned image of a check may warrant to any other institution that the same check will not be subsequently re-deposited at the other institution, and thus assume responsibility if the check is then re-deposited.

In other embodiments, the processing system could generate alerts to only the institution providing the most recent data record (that gave rise to the match against a prior check), or alternatively generate records to institutions other than the two having the original data record and the subsequent record that matched. As an example of this last mentioned case, a third party institution that maintains the account against which the check is drawn might receive an alert (e.g., in order to be made aware of suspicious or fraudulent activity on the account), even though it has not itself submitted checks for detection of duplicates.

FIG. 4 is a flow diagram illustrating yet another embodiment in which filters are applied, risk factors associated with the match of two check transactions are assessed, and notifications are generated in accordance with that assessment. In such embodiment, a transaction record for a check is received at step 410 and compared against prior data records at step 412. If there is no match (step 420), the received data record is stored (step 450). If there is a match at step 420, then the processing system applies filters to the match (using noise suppression module 210) to eliminate transactions that might give rise to a false match, step 422. As examples of check transactions that might be filtered, checks drawn against accounts used for specified purposes, e.g., used for cashier's checks, used for payroll checks and used for rebate checks, could be filtered out, since such checks might be likely to have similar characteristics such as purposely pre-printed identical serial numbers, similar/identical amounts, identical dates, or the like.

As another example of filtering, an institution submitting a check for review might request only alerts for certain types of check deposits (such as remote deposits using check images), since the institution may consider the risk of counterfeit paper checks to be low. Types of deposits (or other check transactions) are referred to herein as “channel indicator types,” and further examples of how they might be considered in the operation of system 110 will be given later.

As yet another example of filtering, when a check is deposited (e.g., in paper form) at a bank and its record sent to system 110, and if a second transaction record for the same check is received within a relatively short period time or window (elapsed time) after the first transaction record (say, thirty minutes) from the same bank, then such a match may be filtered out since it is likely that a clerk or teller at the bank has inadvertently scanned the same check twice, and there is no need for an alert to that bank. The filter could involve several different and successive time windows for the same check in order to determine whether or not to suppress matches. For example, during an initial window (thirty minutes), any duplicate is suppressed given the likelihood that it has resulted from an inadvertent processing error at the depository bank or branch. After the initial thirty minutes, the window for identifying or recognizing duplicates could be re-opened (and no longer suppress duplicates), since duplicates are now less likely to be inadvertent. Then, say, after six months the window again closes or suppresses duplicates and alerts. For example, at this point a check is stale and unlikely to be accepted by a bank, and any incoming data record giving rise to a match may have been erroneously generated. Time windows for suppressing duplicates could be adjusted to be smaller or larger, for example, depending on the type of account (consumer account vs. business account) or other factors.

The filtering of step 422 as described could be based on elapsed time between the transactions conducted at the affected financial institutions corresponding to the matched records or on the elapsed time between receipt of the matched data records at the system 110.

In accordance with another embodiment, at step 424 the processing system could then assess risk factors that might be associated with a duplicate check or with the circumstances surrounding its match to an earlier check, using risk scoring/analysis module 212. Examples of factors that might be assessed at step 424 are shown in Table I:

TABLE I
Exemplary Risk Factors

Type of account against which check is drawn (e.g., consumer account,
business account, or account internal to bank that is used for cashier's
checks and other teller activities)
Account aging (how long the account in question has been in existence)
Whether the matching check was deposited at same bank/branch as the
earlier check
Whether the matching check was for the same amount as the earlier
check
Time elapsed between deposits of the matching check and the earlier
check
Channel used for deposit (channel indicator type)
History of account against which the duplicate checks have been drawn
(e.g., prior incidents of fraud/suspicious activity)

The exemplary factors above (as well as other factors) could be considered together and weighted equally or differently to assess risk. Different participating institutions may assign different weights to different factors, and in some cases the institutions using the risk data will choose different weights depending on their own experiences or their risk tolerance. For example, data could be collected and then statistically reviewed to identify patterns of events which predict an outcome. For example, the design of a risk model could be based on analysis of large numbers of past transactions (involving many consumers, their banks, and the parties to whom they make payments or receive payments), and the characteristics of such transactions. Based on that empirical and experiential data, predictive data can be generated as to how any given set of circumstances surrounding a check might predict the future risk of duplicate checks. The predictive characteristics are identified and then built into a model within module 212. In alternative embodiments, neural models or rules models may be used instead of statistical models.

As an example of how the earlier described factors could be evaluated, in one model an institution might provide three fields of specific data appearing on the check (ABA routing number, account number and serial number). The amount might be ignored in such a risk model, since an amount could be altered (by a fraudster) on a duplicate check to avoid detection as a duplicate. In another model, an institution might provide the amount of the check (as a fourth field), and the amount could be a factor indicating higher risk. For example, in some circumstance, two matched checks (but with different amounts) might be given more weight as a risk since they might indicate an attempt to differentiate two otherwise duplicate checks. On the other hand, an institution might give the existence of checks with different amounts less weight (for risk of fraud), especially for certain accounts (e.g., payroll checks, where different payment amounts for different employees would be expected).

Also, channel indicator types (indicating the manner in which the check is presented to an institution) could be used to assess risk (in addition to use in filtering out matches as described earlier in connection with step 422). For example, checks deposited remotely could be assigned a greater risk weight. In some circumstances the channel indicator types for both the later matching check and the earlier check (against which the later check was matched) could be used. For example, when both the earlier and the later (duplicate) check were deposited remotely, the risk could be weighted higher. If the earlier check were deposited (in paper form) at a bank, and then the later check were deposited remotely, then the risk could be assessed and weighted much higher in some circumstances (e.g., such a pair of channel indicators would normally be unexpected for a consumer account, and might indicate a paper check lost in transit by the bank and used by fraudsters). In other circumstances, such a factor could be weighted much lower, for example, when the account involved is used for payroll checks and it would be expected that two different checks bearing the same serial number might be separately presented for deposit (with the same or different channel indicators).

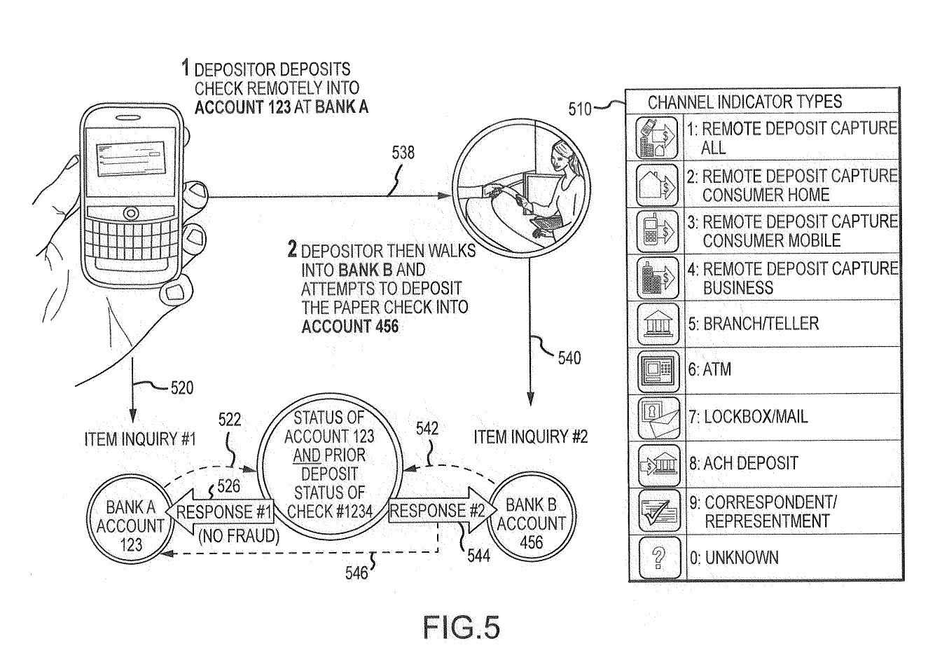

Briefly referring to FIG. 5, there is shown a table 510 of exemplary channel indicator types. Indicator Type 1 is “Remote Deposit Capture—All,” reflecting all forms of remote capture (of a check image) regardless of the type of account or device used. Indicator Type 2 is “Remote Deposit Capture—Consumer Home,” reflecting remote capture at a device (such as a desk top computer) known to be used at a home location. Indicator Type 3 is “Remote Deposit Capture—Consumer Mobile,” reflecting remote capture at a portable device (at any location). Indicator Type 4 is “Remote Deposit Capture—Business,” reflecting remote capture at a business location, such as at a merchant POS terminal. Indicator Type 5 is “Branch/Teller,” reflecting deposit of a physical check at a teller window of a bank. Indicator Type 6 is “ATM,” reflecting deposit of a physical check at an ATM (e.g., using a deposit envelope). Indicator Type 7 is “Lockbox/Mail,” reflecting deposit of a physical check at a bank lockbox or received by a bank in the mail. Indicator Type 8 is “ACH Deposit,” reflecting a deposit received electronically at a bank and not involving a physical check. Indicator Type 9 is “Correspondent/Re-Presentment,” reflecting a check that has been presented to a bank more than once (e.g., in the original presentment, the check might have been returned), and Indicator Type 0 is “Unknown,” reflecting that the manner of presentment or deposit is not known, which may occur if the submitting institution has not indicated a channel indicator type.

It should be appreciated that each of the channel types indicated could present different levels of risk (either as to individual checks or when considered for both the earlier check and the later duplicative check), and either the institutions requesting alerts or the administrator/operator of the detection system could weigh channel indicator types to reflect those different risks.

It should also be appreciated that the channel indicator types (as well as other exemplary risk factors identified in Table 1) could be used either for filtering duplicate transactions (step 422) or for assessing risk factors (step 424).

Returning to FIG. 4, after the risk factors have been assessed, the processing system determines (perhaps based on a score generated at step 424) whether the duplicate checks are likely a result of improper or fraudulent use of the same check, step 426, and if so, an alert (or multiple alerts to different institutions) are generated at alert module 214 and sent by the system 110, step 428. It should be appreciated that in sending an alert, a risk score could also be sent to each affected institution, to permit the institution to better understand the risk and determine what kind of remedial action to take, step 440. Remedial action could include various steps (depending on the assessed or perceived risk), such as freezing or suspending all activity on an account, (e.g., the account into which the check is deposited or the account against which the check was drawn), putting a hold on any future deposits into an account, or notifying authorities (e.g., in situations where there appears to be a clear pattern of criminal behavior).

Finally, in FIG. 4, the transaction submitted for review is stored at a data storage device (such as device 140).

FIG. 5 illustrates, among other things, a simplified example of duplicate checks presented for deposit and messages that are generated in response (such as by alert module 214). In this example, a check is first deposited remotely, and then later presented to a bank teller for deposit (channel indicator types 3 and 5, respectively). As illustrated at Step 1, a deposit is made remotely to an account (Account 123) at a bank (Bank A) as represented by arrow 520. Bank A sends an inquiry to a duplicate detection system (such as system 110) as represented by arrow 522. In response to the inquiry, a Response #1 from the duplicate detection system indicates no prior duplicate checks and no fraud (arrow 526). As illustrated at Step 2, the same depositor then later attempts to deposit (arrows 538, 540) the same check (as a paper check) to an account (Account 456) at a different bank (Bank B). Bank B sends an inquiry to the duplicate detection system (arrow 542). The duplicate detection system returns a Response #2, as a message (arrow 544) to Bank B and a message (arrow 546) to Bank A indicating that the check presented to Bank B for attempted deposit into Account 456 is a duplicate of the check earlier presented at Bank A. Bank A and Bank B are then capable of taking whatever remedial action is warranted by the notices, as discussed in relation to step 440 of FIG. 4 above.

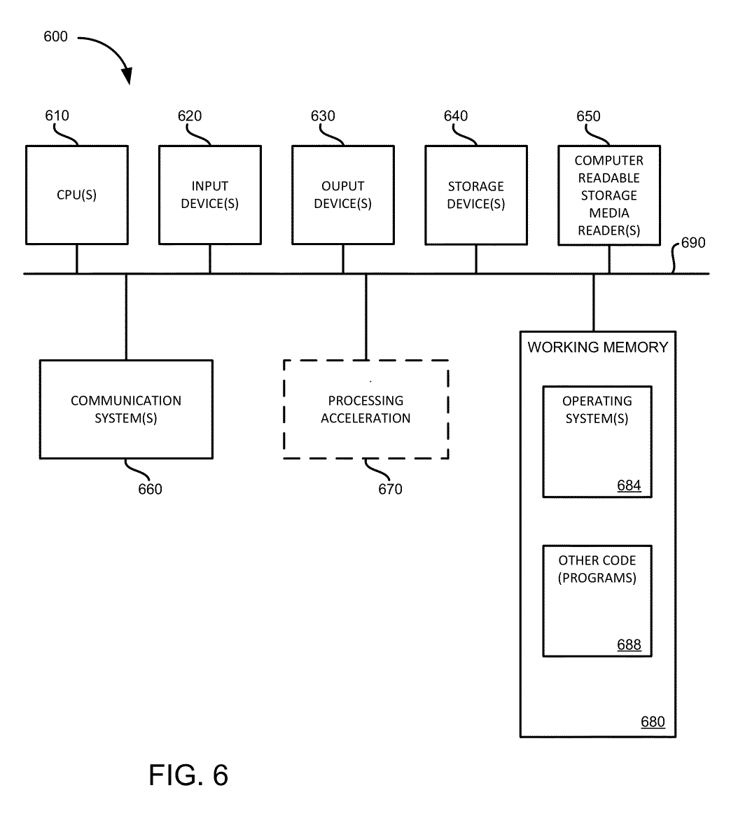

FIG. 6 is a block diagram illustrating an exemplary computer system upon which embodiments of the present invention may be implemented. This example illustrates a computer system 600 such as may be used, in whole, in part, or with various modifications, to provide the functions of the duplicate transaction detection system 110, as well as other components and functions of the invention described herein.

The computer system 600 is shown comprising hardware elements that may be electrically coupled via a bus 690. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage devices 640, representing remote, local, fixed, and/or removable storage devices and storage media for temporarily and/or more permanently containing computer-readable information, and one or more storage media reader(s) 650 for accessing the storage device(s) 640. By way of example, storage device(s) 640 may be disk drives, optical storage devices, solid-state storage device such as a random access memory (“RAM”) and/or a read-only memory (“ROM”), which can be programmable, flash-updateable or the like.

The computer system 600 may additionally include a communications system 660 (e.g., a modem, a network card—wireless or wired, an infra-red communication device, a Bluetooth™ device, a near field communications (NFC) device, a cellular communication device, etc.) The communications system 660 may permit data to be exchanged with a network, system, computer, mobile device and/or other component as described earlier. The system 600 also includes working memory 680, which may include RAM and ROM devices as described above. In some embodiments, the computer system 600 may also include a processing acceleration unit 670, which can include a digital signal processor, a special-purpose processor and/or the like.

The computer system 600 may also comprise software elements, shown as being located within a working memory 680, including an operating system 684 and/or other code 688. Software code 688 may be used for implementing functions of various elements of the architecture as described herein. For example, software stored on and/or executed by a computer system, such as system 600, can be used in implementing the processes seen in FIGS. 3 and 4.

It should be appreciated that alternative embodiments of a computer system 600 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the duplicate transaction detection system 110 may be implemented by a single system having one or more storage device and processing elements. As another example, the system 110 may be implemented by plural systems, with its respective functions distributed across different systems either in one location or across a plurality of linked locations.

Moreover, while the various flows and processes described herein (e.g., those illustrated in FIGS. 3 and 4) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise.

Consequently, although the invention has been described with respect to exemplary embodiments, it will be appreciated that the invention is intended to cover all modifications and equivalents within the scope of the following claims.

What is claimed is:

1. A method for determining that a transaction instrument has been used for conducting more than one transaction, comprising:
receiving, at a duplicate detection system, data records identifying instruments being presented to conduct transactions at one or more institutions;
storing the data records at the duplicate detection system;
when a data record is received at the duplicate detection system, comparing the received data record to the stored data records, to determine if the received record identifies the same instrument that is identified in any one of the stored data records; and
if any two data records appear to identify the same instrument, generating an alert at the duplicate detection system for at least one of the institutions where that instrument has been presented.

2. The method of claim 1, wherein the transaction instrument is a negotiable instrument, and wherein each data record includes instrument characteristics, the instrument characteristics comprising one or more of:
a routing number;
an account number;
an instrument serial number; and
an amount associated with the instrument.

3. The method of claim 2, wherein the negotiable instrument is a check.

4. The method of claim 1, further comprising:
assessing the risk that the identified same instrument is being used to conduct an improper transaction; and
providing the alert and the assessed risk to at least one of the institutions.

5. The method of claim 1, further comprising:
assessing the risk that the identified same instrument is being used to conduct an improper transaction, based on one or more of the following risk factors:
a type of an account against which the instrument is drawn;
how long the account against which instrument is drawn has been in existence;
whether the two data records appearing to identify the same instrument result from presentment of the same instrument at the same institution or at different institutions;
an elapsed time between presentment of the same instrument;
a channel indicator for presentment; and
a history of the account against which the instrument is drawn.

6. The method of claim 1, further comprising:
applying a filter to suppress an alert at the duplicate detection system for at least one of the institutions, wherein the suppression of the alert is based on one or more of the following:
a purpose of an account against which the instrument is drawn;
a type of presentment represented by the data records that appear to identify the same instrument; and
an elapsed time between presentment of the same instrument.

7. The method of claim 6, wherein the instrument is a check, wherein the type of presentment is a channel indicator type, and wherein the channel indicator type reflects at least one of the following types of presentment:
all forms of remote instrument image capture;
remote instrument image capture at a device used at a home location:
remote instrument image capture at a portable device;
remote instrument image capture at a business location;
instrument presentment at a teller window of a financial institution;
deposit of the instrument at an automated teller machine (ATM);
deposit of the instrument at a financial institution via lockbox or mail;
deposit received electronically at a financial institution through an automated clearinghouse (ACH);
presented to a financial institution more than once; and
a manner of presentment is not known.

8. The method of claim 1, further comprising providing the alert generated at the duplicate detection system to each of the institutions where the identified instrument has been presented.

9. A method for identifying a transaction instrument used to conduct more than one transaction, comprising:
receiving, at a duplicate detection system, data records identifying instruments being presented to conduct transactions at one or more institutions;
storing the data records at the duplicate detection system;
when a data record is received at the duplicate detection system, comparing the received data record to the stored data records, to determine if an instrument identified by the received record has characteristics similar to characteristics of an instrument identified in any previously stored data records; and
if any two data records are likely to identify the same instrument based on two data records having similar instrument characteristics, generating an alert at the duplicate detection system for at least one of:
an institution where the instrument has been presented;
an institution that maintains an account against which the instrument is drawn.

10. A system for detecting duplicate transactions, comprising:
a processing system for receiving data records of transactions from one or more institutions; and
a memory device for storing the data records;
wherein the processing system is programmed to:
compare a received data record against data records for prior transactions stored at the memory device;
determine if there is a match of any received data record to a stored data record;
applying a filter to exclude certain matched data records; and
notifying the one or more institutions of matched data records after applying the filter.

11. The system of claim 10, wherein the exclusion of the matched data records by the filter is based on one or more of:
an elapsed time between transactions corresponding to the matched data records;
an elapsed time between receipt of the matched data records at the processing system;
a channel indicator type for a transaction corresponding to at least one of the matched data records;
channel indicator types for transactions corresponding to both the received data record and the matched stored data record; and
a type of account corresponding to the matched data records.

12. The system of claim 11, wherein the processing system is further programmed to assess risk associated with matched data records and to provide a risk score to one or more institutions.

13. The system of claim 10, wherein the data records correspond to checks presented to one or more institutions and wherein the data records include data corresponding to at least one of:
routing number, account number and serial number of the checks; and
routing number, account number, serial number and amount of the checks.

14. A system for detecting duplicates of a transaction instrument, comprising one or more processors programmed to:
receive, at a duplicate detection system, data records identifying instruments being presented to conduct transactions at one or more institutions;
store the data records at the duplicate detection system;
when a data record is received at the duplicate detection system, compare the received data record to the stored data records, to determine if the received record identifies the same instrument that is identified in any one of the stored data records; and
if any two data records appear to identify the same instrument, generate an alert at the duplicate detection system for at least one of the institutions where that instrument has been presented.

15. The system of claim 14, wherein the transaction instrument is a negotiable instrument, and wherein each data record includes instrument characteristics, the instrument characteristics comprising one or more of:
a routing number;
an account number;
an instrument serial number; and
an amount associated with the instrument.

16. The system of claim 15, wherein the negotiable instrument is a check.

17. The system of claim 14, wherein the one or more processors are further programmed to:
assess the risk that the identified same instrument is being used to conduct an improper transaction; and
provide the alert and the assessed risk to at least one of the institutions.

18. The system of claim 14, wherein the one or more processors are further programmed to:
assess the risk that the identified same instrument is being used to conduct an improper transaction, based on one or more of the following risk factors:
a type of an account against which the instrument is drawn;
how long the account against which instrument is drawn has been in existence;
whether the two data records appearing to identify the same instrument result from presentment of the same instrument at the same institution or different institutions;
an elapsed time between presentment of the same instrument;
a channel indicator for presentment; and
a history of the account against which the instrument is drawn.

19. The system of claim 14, wherein the one or more processors are further programmed to:
apply a filter to suppress an alert at the duplicate detection system for at least one of the institutions, wherein the suppression of the alert is based on one or more of the following:
a purpose of an account against which the instrument is drawn;
a type of presentment represented by the data records that appear to identify the same instrument; and
an elapsed time between presentment of the same instrument.

20. The system of claim 19, wherein the instrument is a check, wherein the type of presentment is a channel indicator type, and wherein the channel indicator type reflects at least one of the following types of presentment:
all forms of remote instrument image capture;
remote instrument image capture at a device used at a home location:
remote instrument image capture at a portable device;
remote instrument image capture at a business location;
instrument presentment at a teller window of a financial institution;
deposit of the instrument at an automated teller machine (ATM);
deposit of the instrument at a financial institution via lockbox or mail;
deposit received electronically at a financial institution through an automated clearinghouse (ACH);
presented to a financial institution more than once; and
a manner of presentment is not known.

21. The system of claim 14, wherein the one or more processors are further programmed to provide the alert generated at the duplicate detection system to each of the institutions where the identified instrument has been presented.
